(19) United States
(12) Patent Application Publication
(10) Pub. No.: US 2020/0198751 A1
(43) Pub. Date: Jun. 25, 2020

(54) METHOD AND APPARATUS FOR CONTROL OF AQUATIC INVASIVE SPECIES USING HYDROXIDE STABILIZATION

(71) Applicant: The United States of America as represented by the Secretary of the Department of the Interior, Washington, DC (US)

(72) Inventor: Barnaby Jude Watten, Winchester, WV (US)

(73) Assignee: The United States of America as represented by the Secretary of the Department of the Interior, Washington, DC (US)

(21) Appl. No.: 16/224,810

(22) Filed: Dec. 19, 2018

(51) Int. Cl. B63J 4/00; A01M 21/04; A01M 25/00; C02F 1/66; B01F 3/04; B01D 47/06; B01D 45/12

(52) U.S. Cl. CPC B63J 4/002; A01M 21/043; A01M 25/00; C02F 2103/008; B01F 3/04241; B01D 47/06; B01D 45/12; C02F 1/66

(57) ABSTRACT

An airlift, water mixing system that passes biocides, algaecides and gas through a ship's ballast water tanks and its pipping to control water PH. Vertically moving diffusion grids provide air sparging in treated ballast water that accommodates variances in ballast water levels without changes in pressure or power used by an air compressor connected to a diffusion grid.

### CROSS-REFERENCE TO RELATED APPLICATIONS

This patent application claims the benefit of U.S. Provisional Application No. 62/599,987 filed Dec. 18, 2017. The above application is incorporated by reference.

### FIELD OF INVENTION

This invention relates to a system for treating ship ballast water.

### BACKGROUND OF THE INVENTION

The introduction of nonindigenous (exotic) species into native water has had dramatic negative effects on marine, estuarine, and freshwater ecosystems along with serious human health issues including death in the United States and abroad.

This effect has been primarily due to the need for ships to discharge ballast water when it loads or unloads cargo to offset weight and navigate shallow waters. Water in one region held in a ship's tanks and transported to another region prior to being released or discharged to surface waters have been found to be key source of these species. In 1991 alone, the U.S. waters received approximately 57,000,000 metric tons of ballast water from foreign ports with approximately 40,000 to 50,000 cargo ships operating world-wide annually. This has resulted in a worldwide problem with global, national and state regulations being created to control transport.

Ship surveys have demonstrated that ballast water transport various organisms like planktonic and nectonic organisms capable of passing through coarse ballast water intake screens. These include bacteria, larval fish and bloom forming dinoflagellates. Known control systems involves costly, time consuming use of filtration, UV light treatment, ozonation or application of other biocides that include chlorine, quaternary and polyquatenary ammonium compounds or aromatic hydrocarbons. However, due to typical, volumes and flowrates, large vessel in fresh water can carry in excess of 200,000 m3 of ballast water, which is released at very high flowrates during cargo loading operations, such as flowrates approaching 200 m3/min. Such flow rate requires large amounts of designated water treatment space to accommodate these rates, resulting in increased energy consumption and cost.

These prior methods due to the treatment reagents, power consumption and processing time have led to unwanted environmental effects such as deaths to native fish, increased cost and ship corrosion of steel ships. Corrosion prevention represents about 10% of the original cost of the ship and corrosion related maintenance/downtime represents a large part of the variable costs of ship operation totaling upward of $10.6 billion world total.

Based on the problems indicated above and for reasons that will become apparent by the reading of this application there is an unmet need in the art for new speedy, cost saving and environmentally safe control strategies capable of meeting regulations set out for the discharge of ballast water.

The invention enables ships to meet those standards, while retarding corrosion, eliminating residual toxicity found from engine exhaust, reducing water treatment space, energy consumption and shipping cost through an accelerated treatment time that increases a ship's revenue potential that accommodates tight shipping schedules.

### SUMMARY OF THE INVENTION

A system, method and apparatus for treating ballast water that avoids unwanted effects associated with common invasive species water treatment.

The treatment eliminates targeted invasive species at an accelerated rate by exploiting their sensitivity to elevated pH (hydroxide stabilization) throughout Ballast tanks and ship piping exposed to water. The approach is based on flowing air without concern for back pressure in an upstream air compressor through moving grid structures located in a ship ballast tanks that enables uniform distribution and mixing of one or more common base reagent(s) such as sodium hydroxide, potassium hydroxide, hydrated lime, NaOH, KOH or Ca(OH)2 or any other base additive known in the art, individually or in combination, within a ballast water to create a pH >11.0. It has been found that where pH of the ballast water was elevated to more than 11, targeted species were eliminated from 99-100% within 24-48 hours.

A moving grid along with system's pipe configuration interconnects the ships ballast tanks, which permits the operation of each grid to run off a single low to moderate air source compressor without concern for upstream back pressure of the compressor due to changes in water tank levels. This eliminates an increase in cost by removing the need to include in the ship's design, multiple or large, high powered compressors to accommodate both the maximum and minimum volumes of the ships' ballast tanks.

Moreover, in the preferred embodiment of using NaOH, KOH or Ca(OH)2 , the reagents provide sources of alkalinity in surface waters, resulting in the stoichiometry for both NaOH and Ca(OH)2 reacted with CO₂ as:

2NaOH+CO₂=H₂O+2Na⁺+CO₃²⁻

Ca(OH)₂CO₂=H₂O+CaCO₃

This increase in alkalinity provides not only a corrosion inhibitor for ship metals, but the release of products like of sodium bicarbonate, potassium carbonate or calcium bicarbonate in the receiving water. The by-product is known to be advantageous to the environment including producing a buffer of acid rain to protect fish and aquatic life.

Further, the hydroxide stabilization process does not require a pretreatment step designed to mechanically filter organisms prior to the introduction of the ballast into the ballast tanks. This later trait provides for a dramatic reduction in capital requirements and energy requirements linked to pumping heads.

The base application treatment step is followed by exposure of the ballast tank to a gas source, such as CO₂ from two to twelve hours to lower or depress the pH of the exposed ballast waters to or just below legally required discharge permit levels Post mixing can occur after CO₂ is mixed into ballast water with either compressed air or another pH elevator placed within the Ballast Tank to achieve targeted pH levels and replenishment of oxygen in the ballast water that meets discharge standards.

The post mixing step may be repeated by air from compressor passing through the grid, 40, causing oxygen to be replenished as air is mixed in to the ballast water increasing pH water levels.

Additionally, post treatment of water may include pH adjustment to within the range of 6.5-9.0 or ballast water discharge standards. For example, if residual sulfurus acid is found present in the ballast tank's water following use of combustion exhaust gas. A pH elevator may be made through the addition of one or more base reagents such as sodium hydroxide, hydrated lime or limestone.

Additionally, the unique piping for the gas source has been designed to permit exposure from either commercial CO₂ through optional air feeds or CO₂ recovered from marine engine exhaust streams or other combustion processes. The CO₂ normalizes the ballast water's pH to levels allowed by law for release into native waters eliminating concern for residual toxicity.

In operation, the components illustrated are used in the following steps: 1), initiation of the charge of the ballast tank with water during cargo unloading operations, along with the subsequent dosing of the water entering the ballast tank with NaOH, KOH or Ca(OH)2 or other strong base reagent, 2), a continued fill of the ballast tank with ballast water up to a target level upon completion of the dosing step, 3) a mixing step designed to homogenize the water chemistry, using the diffuser grid with the compressor drawing air from the optional air line shown, 4), a holding period of the ballast water in the tank from 24 to 48 hours at the resultant elevated pH so as to achieve the desired biocidal effect, 5), the introduction of cooled and cleaned engine exhaust containing CO₂ into the ballast with bulk mixing so as to reduce ballast pH to levels safe to discharge into receiving waters, 6), a final mixing step that includes air sparging so as to remove any excess free CO₂ or volatile compounds related to exhaust use through stripping and to add dissolved oxygen to the ballast water replacing that lost during the carbonation step, 7), a check of the water chemistry either manually or through automated sampling so as to insure compliance with discharge standards and finally, 8), release of the ballast from the ship during cargo loading operations. This will be referred to hereafter as the Standard Treatment Process (STP).

In the exemplary embodiment shown, the pH level of the water in the ballast tank is adjusted to an effective pH level at 11 or above to kill the targeted invasive species. However, in the alternative embodiments, the treatment system can also be used to introduce contents to control pH of ballast water to reach levels as desired to either exceed pH mortality of invasive species or to condition ballast water to pH and oxygen levels that meet the various discharge standards set throughout the world.

As an example, pH level may be increased by systematic introduction of sodium hydroxide, potassium hydroxide, hydrated lime, or any other base additive known in the art, individually or in combination. In some embodiments, the pH level of the ballast water may be raised to a level of 10 to 12 to eradicate microorganisms. In other exemplary embodiments, the pH level may be reduced to a level of less than six to eradicate microorganisms.

The effective pH level and/or range may vary, considering other factors present which also affect the survival rate of non-indigenous species, including temperature, as well as dissolved solute concentrations including magnesium and organic components.

In still another embodiment, algaecide either alone or in combination with biocides may be introduced into the system to kill the targeted species.

### BRIEF DESCRIPTION OF THE DRAWINGS

FIG. 1 illustrates an exemplary airlift mixing system and ship engine exhaust gas scrubbing system for treating non-indigenous species in ballast water.

FIG. 2 illustrates an enhanced embodiment of an exhaust purification system, which recycles engine exhaust to create a clean source of CO₂.

FIGS. 3A and 38 illustrate two views of an exemplary embodiment of a diffusion grid installed in a ballast tank.

FIG. 4A is a piping plan diagram for improved circulation between eight ballast tanks, using one circulation pump.

FIG. 4B is an alternative piping plan diagram for improved circulation between two groups of four ballast tanks, using two circulation pumps.

### TERMS OF ART

As used herein, the term “additive” means a chemical substance added to ballast water to increase or decrease the pH level. Additives may be classified as a base, an acid, or CO₂.

As used herein, the term “air sparger” or “air lift” means movement of large volumes of water in tank due to generated air bubbles in a manner where bulk water follows a vertical path from lower part of tank to the open area above volume of water; once exposed, the water flows in multiple directions resulting in agitation and mixing of the water.

As used herein, the term “base additive” or “base solution” means a chemical substance used to raise the pH level of ballasti water, including but not limited to hydrated lime, sodium hydroxide, and potassium hydroxide.

As used herein, the term “diffuser grid” means an air delivery system with apertures geometrically spaced and optimized to vary and control the formation of air bubbles or plumes for airlift.

As used herein, the term “effective pH level” means a pH level within a range that is lethal or effective to eradicate aquatic organisms in a ballast tank, considering all relevant environmental conditions including temperature, pressure, and salinity. An effective pH level is either above or below the range at which microorganisms can survive.

As used herein, the term “effective quantity” means a quantity of an additive that produces an effective pH level when added to ballast water.

As used herein, the term “plume” means a column of one fluid moving through another with a different velocity, producing turbulence.

### DETAILED DESCRIPTION OF THE INVENTION

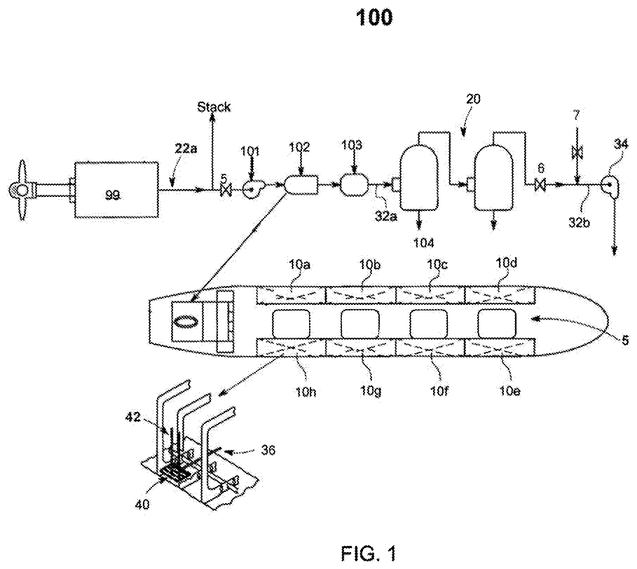

FIG. 1 illustrates an exemplary embodiment of an airlift mixing system 100 for treating non-indigenous species found in water within ballast tanks, 10a . . . h of a ship, 5. pH increasing base reagent(s) such as NaOH, KOH or Ca(OH)2 are fed into the tanks, 10a . . . h, where water and the reagents are caused to mix by air generated from a compressor, 34, passing through a diffusion grid, 40, placed between traverse web frames, 6, in each tank, 10.

The diffusion grid, 40, is a hollow casing made from a hard material preferably steel or PVC with intersecting ribs. In the present embodiment, guide rails, 42, pass through the grid, 40, to allow vertical movement of the grid based on changes to water level within each tank, 10.

An air compressor, 34, blows air through an air or gas supply pipe, 36, that extends from the compressor, 34, to the diffusion grid, 40, such that the grid, 40, acts as an air sparger producing air bubbles plumes in the tank's, 10, water. Each rib acts as a sparger conduit pipe that has apertures, sized and shaped to discharge pressurized air in ballast water over across-sectional area defined by the location of the apertures. The bubbles or plume rises vertically generating an airlift, mixing the reagents and water within the tank, 10a . . . h.

Reagents are held and mixed within the ballast water tanks, 10a . . . h, for a preselected period to achieve the targeted elevated pH to achieve killing of targeted invasive species. Prior to ballast water tank discharge, CO₂ is introduced into the tanks, 10a . . . h, from engine, 99, exhaust or alternatively through an inlet in ship's piping to lower ballast water pH levels to meet permit discharge standards.

Piping configuration that extends from engine, 99, allows ship exhaust, 22a, that typically has 6% carbon dioxide, CO₂, and a lesser amount of carbon monoxide, CO, to be blown through a fan, 101, to accommodate pressure drops in system to an inline heater or burner, 102. Burning diesel fuel in the heater will increase in the CO₂ content of the gas stream as the fuel reacts with the residual oxygen present in the engine exhaust to approach 12-14% by volume. Hot engine exhaust is then pulled through the catalytic converter for remaining reduction of carbon monoxide and increases in CO₂.

The effect of burning fuel has additional important and positive effect on treatment costs of the ship. The volume of gas that must be delivered to the ballast tanks will be reduced providing a 50% savings in: gas compression energy and capital costs; scale and cost of operating the secondary spray nozzle scrubber; and number or scale of the gas spargers/plumbing required. Alternatively, the increase in CO₂ to 12-14% could allow the time required for the pH depression step to be reduced in duration by 50% providing for extended treatment soak periods at sea as well as reduced process operating costs. The cost of the fuel required in the preheating step is a small fraction of the savings in capital and operating costs linked to gas scrubbing and delivery just described.

The remaining exhaust flows through an exhaust purification system, 20, to clean and remove particulates including carbon based materials and to cool the gas temperature by dissipating heat 104, from the gas stream to be fed to compressor, 34. Valves, 5, 6 are placed upstream from the fan and downstream from the exhaust purification system, 20, to provide an optional CO₂ source for pH control into ballast water. Where commercial or external CO₂ is provided directly in ship's piping, it may be through a gas inlet with valve, 8 between the exhaust purification valve, 6, and compressor, 34.

After the ship's mixing with CO_{2,} a gas without CO₂ may flow into the tanks, 10 through the diffusion grid, 40, and repeat mixing step within the tank, 10, to remove any excess CO₂ or volatile compounds related to exhaust use through stripping and adds dissolved oxygen to the ballast water replacing that lost during initial tank, 10, exposure to CO₂. A check of the water chemistry by known methods in the art is used to insure compliance with discharge standards.

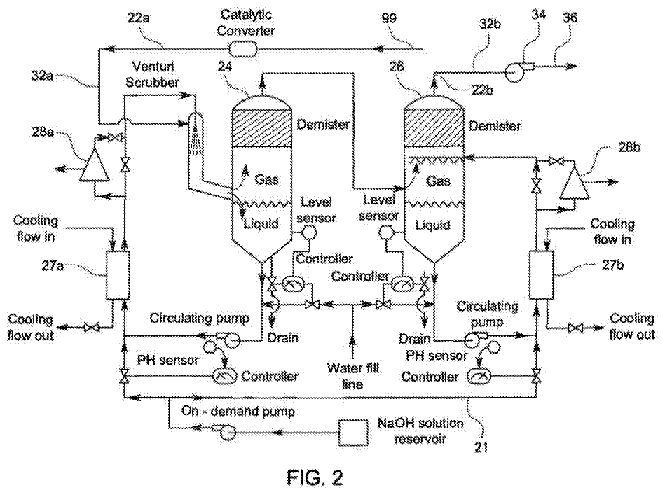

FIG. 2 illustrates an enhanced design exhaust purification system, 20 to remove contaminants present in ship exhaust following treatment with a catalytic converter. Exhaust gas stream, 22a is conveyed by exhaust gas pipe, 32a, from engine, 99, to the purification system, 20, where CO₂ exhaust is cleansed and cooled, down to be safely injected into cleansed gas pipe, 32b, that conveys cleansed CO₂ stream, 22b, to one or more gas compressors, 34, to create a safe, clean pressurized CO₂ stream that flows into pipe, 36.

The exemplary embodiment shown, the exhaust purification system, 20, is comprised of: venturi chamber 24, slurry chamber, 26, pH control loop, 21, heat exchange assemblies 27a and 27b, that cools down the heated, exhaust stream, 22, a filtration system solids separation and removal assemblies, 28a, and 28b, exhaust gas pipe, 32a, cleansed gas pipe, 32b, gas compressor, 34, and gas supply pipe, 36.

Particulates reduced include carbon, solids and dissolved material, polynucleac aromatic hydrocarbons (PAHs), nitrites nitrates, and heavy metals to avoid releasing contaminants into ballast water and the environment.

Exhaust gas pipe, 32a directs exhaust gas stream 22a from the catalytic convener of engine, 99, to venturi chamber, 24. Exhaust gas stream, 22a is approximately 600 degrees Fahrenheit when it enters venturi chamber, 24. A sprayer by conventional techniques within the venturi chamber, 24, sprays water through exhaust gas stream, 22a, to cool the gas stream and reduce its volume. The water also bonds to contaminants in the gas stream and flushes them out of venturi chamber, 24. Flushed contaminants include nitrous oxide, sulfur dioxide, and carbon.

After passing through the water spray, the cooled, exhaust gas stream, 22a, exits venturi chamber, 24, by passing through a demister or water mist removal component, 30, which is a porous surface with which moisture and water droplets in the gas stream collide and are removed from the gas stream.

After exiting venturi chamber, 24, exhaust gas stream, 22a, enters slurry chamber, 26, designed specifically to reduce PAH, heavy metals and additional NOx components. This is achieved in the chamber, 26, incorporating one or more spray nozzles, 31,emitting a cooling recirculated solution of water and peat counter-current that may be provided through an inlet or access port in chamber, 26, or other known methods, cross-current or co-current with regards to the gas stream. The peat would be ground to a particle>size that will not interfere with normal nozzle operation, i.e., preferably less thaw 1 mm. The combination of the high specific surface area of the water droplets emitted by the nozzles, along with high surface renewal rates favoring mass transfer, allow the target contaminants to enter the solution phase whereupon they are adsorbed by the suspended peat adjunct. Upon termination of the gas scrubbing step, or upon the peat particles becoming saturated with contaminants (spent), peat particles can be removed from the suspension by a centrifugal type separator, 28b, or other filtration means and again, readied for disposal at port or incineration separating gas from liquids.

If removal of peat occurs during operation of the scrubbing system then provisions can be made for the concurrent addition of equal amounts of fresh peat via a variety of means including an auger drawing peat from a storage bin, a vacuum assisted dispenser of fixed quantities of peat or through pumping of a peat suspension.

Peat is a relatively inexpensive adsorbent widely available with important deposits in Canada, Florida, Michigan and Minnesota. Examples of peat may include petroleum hydrocarbons, PAH's, alkylphenols metals such as cadmium, copper, chromium, lead, mercury, nickel and zinc, nitrite and phosphorus. Non-polar components of peat, including waxes and methyl groups, have an affinity for organic molecules while the functional groups carboxyl, hydroxyl and carbonyl groups attract metals and polar compounds. Peat characteristics that favor adsorption of hydrocarbons include a low fiber content, a high ash content, high levels of guaiacyl lignin pyrolysis products and high levels of furan pyrolysis products. Alternative adsorbents include clays, zeolites and activated carbon materials.

After passing through the slurry spray, 31, the exhaust gas stream, 22a, exits slurry chamber, 26, by passing through a water mist removal component, 30b, which is a porous surface with which moisture and water droplets in the gas stream, 22a, collide and are removed from the gas stream, 22a.

pH Sensors, 32a, 32b that detect the liquid levels in venture chamber, 24, and slurry chamber, 26, may be added to move excess liquid in the venture and slurry chambers, 24, 26, to an optional pH control loop, 21, which includes valves, 35a, b, water conduit pipes, a pH sensor, 32a, 32b, arid a base dispersal component. The base dispersal component is a pump, 33a, 33b, operatively coupled with a reservoir, 34, containing a base, which is a chemical with a high pH. When the pH sensor detects a pH in the liquid in pH, control loop, 21, that is below a user defined threshold, base dispersal component releases base into the liquid in pH control loop. The control of pH here is important given the need to reduce the corrosion of metal scrubber components linked to acid gases present in the exhaust stream being treated including CO_{2,} SO₂ and some NOx compounds. Left unabated, corrosion can lead to an accumulation of heavy metals in the recirculating water streams that are in direct contact with the exhaust gas stream, 22a, leading to the carryover of the heavy metals through the piping and into the ballast water tanks (not shown).

The liquid in venturi chamber, 24, and slurry chamber, 26, absorbs heat from exhaust gas stream 22a before moving into pH control loop 21. Heat exchange assemblies, 27a, b, reduce the temperature of the liquid in pH control loop, 21, before conveying the liquid to solids separation and removal assemblies 28a and 28b. Solids separation and removal assemblies, 28a, b, remove solid waste and adsorbent material. Solids are pulled and cycled from the reduced temperature liquid found in chamber, 24, passing through spray, 31a and out of chamber, 24, before conveying it to the spray, 31b, and in slurry chamber 26.

Exhaust gas stream, 22a then exits slurry chamber 26 as cleansed CO₂ stream, 22b, which is cleansed of particulate matter arid rich in CO₂. Cleansed gas pipe, 32b, conveys cleansed CO₂ stream, 22b to one or more gas compressors, 34, that is used to create a suction force that pulls purified gas through the two stage scrubber and then forces the product gas via gas supply pipe, 36, that may be a flexible tubing connected to diffusion grids, 40, (not shown) located in each ballast tank (shown in FIG. 1).

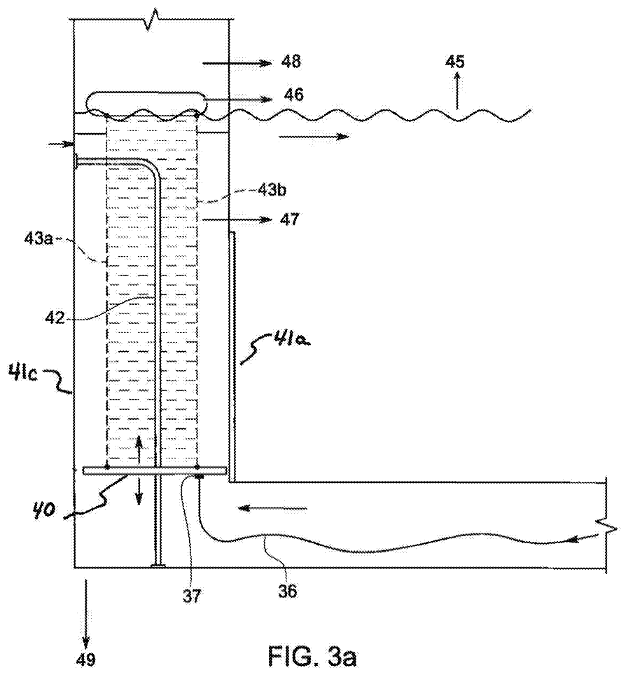

FIGS. 3A illustrate a side view of the diffusion grid, 40, near tank bottom, 49, in ballast water, 45 surrounded by ship's confinement wall, 41c, 41a that is the outboard wall of the ballast tank. At least one orientation guide rail, 42 passing through the, diffusion grid, 40. A float, 46, on top, 10, not shown, of the ballast water, 45 moving with the depth of water in the tank. At last one connector, 43b, including a chain connected from the float, 45 to the diffusion grid, 40, to allow the grid to provide uniform mixing through each tank, 10, regardless of ballast water, 46, level within each tank, Air flowing through pipe, 36, to gas inlet, 37, through the diffusion grid, 40, through apertures (not shown) formed on uppermost top portion of the diffusion grid, 40, produces bubbles that flows toward float, 46. As bubbles, 47, rise to open space, 48, above float, 46, the bubble drags water, 45. As the bubble explodes, portions of water, 46, keeps moving, crashing into the confinement walls, 41c, directing the flow of the water, 45, in opposite directions.

As the water depth in the ballast tank can vary greatly with cargo load and weather conditions forcing required gas compressors serving the diffuser g rids (not shown) to operate over a wide range of discharge pressures. The use of a float, 46, minimize pressure swings to reduce need to vary compressors or compressor scale (capital) or power requirements.

FIG. 3B illustrate another view of an exemplary embodiment of diffusion grid, 40, Orientation guide rails, 42a and 42b, depth adjustment components, 43a and 43 b, such as cables or chains, rib or sparger conduit pipes, 44, with designed apertures 46a through 46cg. In the exemplary embodiment shown, gas inlet, 37, receives pressurized e.g., CO₂ stream, 22c, the diffusion grid, 40, includes a hollow frame, 45, which is coupled with ribs or sparger conduit pipes 44a through 44e, Pressurized CO₂ stream moves through rib, sparger conduit pipes 44a through 44e and exits through geometrically optimized outlet apertures 46a through 46cg to control air lift, water plume formation and achieve a target turnover rate.

In the exemplary embodiment shown, diffuser grid, conduit pipes 44a through 44e are hollow and operatively coupled with a plurality of apertures to disperse and diffuse gas, shown as geometrically optimized outlet apertures 46a through 46cg. The spaces between sparger conduit pipes 44a through 44e allows ballast water to flow through and create water pumping action. The apertures that may be geometrically optimized with a diameter of approximately ⅛ inch to ¼ inch, as determined by allowable pressure drop across the aperture and the presence of debris that may plug the apertures, and the optimal maximum bubble size.

Gas entrained with water in the airlift will be released to the ballast tank headspace which must be vented to prevent pressurization of the ship ballast tank.

Orientation guide components 42a and 42b pass through apertures on opposite sides of sparger conduit pipe 44c and keep sparger conduit pipes 44a through 44e in position to control plume formation. In the exemplary embodiment shown, orientation guide components 42a and 42b are rails attached to plume confinement wall 41c and centered between plume confinement walls 41b through 41d to further optimize water plume movement.

Plume confinement walls 41c and 41d are internal structural components of the ballast tank known as web frames, which are positioned, in one embodiment, 8 feet apart from each other. In those cases where the air diffuser grid, 40, is operated in a position well above the floor of the ballast tank the circulation cell that develops in the bulk fluid may result in a distortion of the cell that causes, in turn, short circuiting and hence reduced rates of tank mixing, i.e., the water entering the airlift from underneath the grid will be pulled from the bulk volume higher and higher in the water strata as the grid moves toward the upper free surface in the tank. This problem can be circumvented by enclosing the movable grid with a shroud or baffle plate that is stationary with an open end near the floor of the tank.

Water moved by airlift action will in this case be required to enter the enclosure through an opening created at the base of the enclosure. Thus, the grid can move up or down behind the wall of the enclosure while maintaining the desired circulation cell that includes picking up the water at or near the bottom of the tank and releasing the water at the top of the tank. The enclosure or plume confinement wall 41a would not extend to the free surface of the water to allow the free movement of the airlift stream away from the side of the tank toward the tanks opposite wall (flow stream is typically perpendicular to the longitudinal axis of the ship). The open area at the bottom of the tank would be sized so, as not to restrict unduly water flow. This allows water to move above and below plume confinement wall 41a and circulate through the ballast tank. The plume rises upward from diffusion grid 40, above plume confinement wall 41a and moves away from diffusion grid 40. Then, ballast water moves toward diffusion grid 40, under plume confinement wall 41a. In various embodiments, plume confinement wall 41a is optional.

Depth adjustment components 43a and 43b allow rib or sparger conduit pipes 44a through 44e to move up and down with the changing level of the ballast water surface. This maintains a constant back pressure on air compressor 34 and reduces the energy required to run air compressor 34. In the exemplary embodiment shown, depth adjustment components 4a and 43b are cables of fixed length attached to a floating device, which has horizontal stopping structures located below the device to prevent the floating device and diffusion grid 40 from sinking below a user-defined depth in the ballast tank. In alternative embodiments, depth adjustment components 43a and 43b are comprised of hydraulic cylinders, pneumatic cylinders, levers, screw jacks, rack and pinion systems, or linear activators and may de operatively coupled with sensors that sense the height of the surface of the ballast water and the depth of diffusion grid, 40.

To create an air bubble water plume, diffusion grid, 40, is optimally placed to alter the specific gravity of a sufficient portion of ballast water. Variation in the specific gravity of the water causes the ballast water to agitate. Based on the design including aperture size and placement of the diffusion grid, air sparger then efficacy and uniformity of mixing and reduction of ship power consumption can be achieved.

The specific gravity of the water nearest diffusion grid 40 is reduced relative to the specific gravity of ballast water that is further from diffusion grid 40, causing the water close to diffusion grid 40 to rise, i.e., the effective specific gravity of the mixture γm is altered such that the following equality is satisfied:

hₘγₘ=h₂γ₆

Where hm=height of liquid-air mixture in the tube

hi=height from free water surface to tube discharge (i.e., pump lift)

m=specific gravity of liquid-air mixture

hs=depth of submergence of air inlet to pump

γ₁=specific gravity of the liquid outside the tube

The head developed, hi, represents the difference between hm and hs.

Airlift pumping rate decreases as hi increases when air flow rate is held constant. Therefore, in ballast applications hi should be minimized to encourage mixing by maintaining a submergence ratio, hs/hm, that approaches unity. In all other applications of airlift pumps the submergence ratio is typically >0.65. Air feed rates are easily regulated with valving to achieve the desired pumping rate under two-phase flow conditions,

Gas compressor 34 and optional valves control the rate at which pressurized CO₂ enriched gas stream 22c (shown in FIG. 3b) enters diffusion grid 40 through gas inlet 37 (shown in FIGS. 3a and 3b) which affects the rate at which air discharges from diffusion grid 40.Higher air discharge, rates create large bubbles with a diameter approximately equal to the diameter of the geometrically spaced and optimized apertures, which achieves a higher turnover rate. Additionally, increased gas/liquid ratios in the plume achieve a higher turnover rate.

The turnover rate is a function of ballast water volume (v) divided by the flow ate (q) of said ballast water circulated by diffusion grid 40. In various embodiments, the turnover rate reflects the amount of time required to circulate the ballast water in the ballast tank once. In various embodiments, treatment requires that the ballast water circulate four to six times.

Achieving the target turnover rate requires a minimum rate at which air is discharged from diffusion grid 40, which is related to the dimension of the plume created by diffusion grid 40, the dimensions of the walls that confine the plume created by diffusion grid 40, and the depth of diffusion grid 40.

In one embodiment, diffusion grid 40 and the airlift plume that it creates is confined by vertical walls on all sides. Here, the relationship between the minimum air flow rate, Qₐₘ, and the wall dimensions and diffusion grid 40 depth are expressed in the following equation:

$${Q}_{am} = \frac{0.35 ( 1 - {M}_{s} ) A \sqrt{gd}}{1.2 {M}_{x} - 0.2}$$

wherein, Qam=minimum discharged air flow required to initiate pumping (cm3/s)

Ms=submergence ratio hs/hm (m/m)

hs=distance (height) between the surface of the ballast water and air sparger gas inlet 37(shown in FIG. 3A)

hm=distance (height) between the top of plume formed by diffusion grid 40 and air sparger gas inlet 37

A=cross-sectional area of diffusion grid 40 (cm2)

g=acceleration of gravity (cm/s2)

d=diameter of the walls that confine the plume (cm)

In alternative embodiments, at least one of the walls is a partial wall that allows water to flow above and below the wall. This equation is redefined with a Geometry factor (Gf), assuming that the top of the plume created by diffusion grid 40 is at the same elevation as the free surface of the ballast water in the tank. The geometry factor reflects the extent to which the plume is enclosed by ballast tank structures.

Qam=Gf*((a(1-Ms)A((gd)0.5))/(b*Ms-c))

wherein, Gf=Pw/Pg

Pw=the continuous horizontal perimeter of the walls that confine the plume created by diffusion grid 40

Pg=the perimeter of the horizontal area where diffusion grid 40 discharges gas

a, b, and c are coefficients from a regression.

Gf is defined as a function of a ratio that describes the degree of confinement, e.g., the perimeter (length, cm) of the confining conduit walls (Pw) divided by the perimeter of the horizontal area receiving gas from diffusion grid 40 (Pg). Pw is measured by taking a horizontal cross section of confinement walls and measuring the interior perimeter of the cross-section. If all, sides of the plume are confined, the cross-section will be a rectangle or other closed shape. If there is an unconfined side of the plume, the cross-section will be open and may resemble a letter U.

In a completely closed conduit, like a pipe section, Pw/Pg=1. In a partially open conduit Pw/Pg will be less than one.

In various embodiments, the number of geometrically optimized outlet apertures is calculated by dividing the total air flow requirement by the calculated air flow per aperture: Qam/Qg. The geometrically optimi outlet apertures are positioned to maximize the cross-sectional area A.

Increasing the size of the bubbles discharged by diffusion grid 40 increases the pumping rate. However, decreasing the bubble size increases gas transfer by increasing the gas-liquid interfacial area per unit volume of agitated water. Increased CO₂ gas transfer rates cause a more rapid reduction in pH level of the ballast water and elimination of organisms in the ballast water. Additionally, smaller bubbles reduce “slip” or the relative velocity difference between the rising bubble and the ballast water, which in turn, reduces the energy loss in a plume Additionally, to prevent smaller bubbles from combining to form larger bubbles, the ideal gas-liquid ratio in the plume is less than 0.1 When this ratio is above 0.1, bubble coalescence occurs due in part to turbulence and gas expansion as the gas liquid mixture proceeds towards the discharge end of the plume. The relationship between bubble size, the diameter of the geometrically optimized outlet apertures, and the density of the gas at the release point is expressed by the following equation.

$${R}_{b} = {0.875 [ \frac{( St ) ( {R}_{0} )}{g ( {ρ}_{e} {ρ}_{g} )} ]}^{1 / 3}$$

Rb=bubble radius (cm)

St=surface tension (g cm/s2)

R₀ diameter of geometrically optimized outlet apertures (cm)

g=acceleration of gravity (cm/s2)

pₑ=density of ballast water at the top of the plume (g/cm3)

p_{g}=density of gas (g/cm3)

In various embodiment additional equations describe the energy requirements of diffusion grid 40. In the exemplary embodiment shown, diffusion grid 40 is designed'to move up and down with changes in the level of ballast water to minimize energy requirements. A decrease in the diameter of geometrically spaced and optimized apertures R0, or an increase in the depth of submergence of gas inlet 37, will increase the energy required to operate diffusion grid 40. The power required to compress a selected mass of air, Qm, increases with the compression ratio as described by the adiabatic compression formula:

Qm=Mass flow rate of gas (kg/s)

R=Gas constant

T1 Absolute temperature of gas at compressor inlet (° K)

N=(K−1)/K, dimensionless

e=Combined efficiency of compressor or pump and motor

Po=Absolute compressor outlet pressure (kPa)

Pt=Absolute compressor inlet pressure (kPa)

Pw, compressor=Power required (kW)

K=Isentropic index for gas mixture, dimensionless

The total energy required to operate diffusion grid 40 will be related to the efficiency of the air compressor, e, as well as losses related to the air distribution system design. Hydraulic efficiency eh, of diffusion grid 40 is defined as the useful work done on the water being moved divided by the isothermal energy of expansion of the air along the length of the plume, as expressed in the follow ing equation:

$${e}_{b} = \frac{{γ}_{l} {Q}_{l} {h}_{l}}{{P}_{a} {Q}_{g} ln ( {P}_{l} / {P}_{a} )}$$

γ₁ =specific weight of liquid N/m3)

Q₁ =flow rate of liquid (m3/s)

h₁=distance from ballast water surface to geometrically spaced and optimized apertures (m)

Pa=absolute atmosphere pressure (Pa)

Qg=gas flow rate (N/s)

P1=atmospheric pressure plus h_{sγ1} (i.e., absolute pressure at bottom end of the plume) (Pa)

The hydraulic efficiency, eh, of diffusion grid 40 can approach 50 to 60% and is related to design variables including flow of both air and liquid the submergence ratio, plume diameter, and discharge head, which is the distance from the ballast water surface to geometrically spaced and optimized apertures. Overall performance correlations for diffusion grid 40 are based on two-phase flow theory and modeling empirical data. The relationship between the volume of air required to pump water versus the height that water needs to rise, known as lift, the depth of submergence of diffusion grid 40, and a constant based on lift is expressed by the following equation:

$$Q = \frac{0.8 {h}_{l}}{C {log}_{10} ( {h}_{2} + 10.36 ) / 10.36}$$

Q=cubic meters of air required to pump 1 liter of water

h₁=lift (meters of water)

C=empirical constant (9981-6355)

h₂=depth of submergence (meters of water)

The rate at which gas transfer occurs during airlift pumping is proportional to the difference between the existing (C) and saturation concentration (C*) of the gas in solution. C* is related to temperature, pressure and gas composition as defined by Henry's Law. In differential form, the relationship is expressed as the following equation:

$$\frac{d c}{dt} = {( {K}_{L} a )}_{r} ( {C}^{*} - C )$$

The overall mass transfer coefficient (KLa) reflects the conditions present in a specific gas-liquid contact system. Conditions of importance include turbulence, waste characteristics of the liquid, the extent of the gas-liquid interphase and temperature. Values of KLa increase with temperature [symbol] as described by the following expression:

(K_{L}α)ᵣ=(K_{L}α)₂₉(1.024)^{r-29}

Although each gas species in a contact system will have a unique value of KLa, it has been established that relative values for a specific gas pair are inversely proportional to their molecular diameters:

KLa is enhanced when gas transfer is followed by chemical reaction, such as CO₂ movement into ballast water followed by a reaction with hydroxide (OH) present due to the dosing of the ballast with NaOH, KOH or Ca(OH)2.

The upper end of an airlift can be fitted with an, elbow positioned at or near the surface of the free surface of water in the ballast tank to induce a discharge current parallel with the water surface. Alternatively, the discharge can be vertical with the change in bulk flow established without an elbow by the discharge encountering the free surface of the ballast water in the tank.

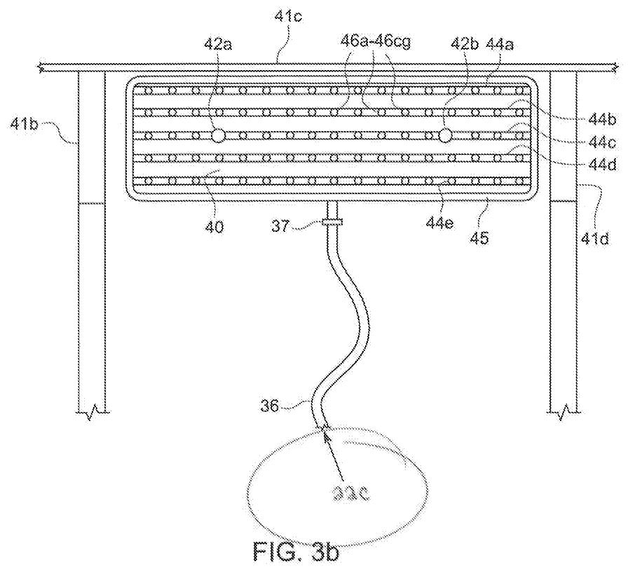

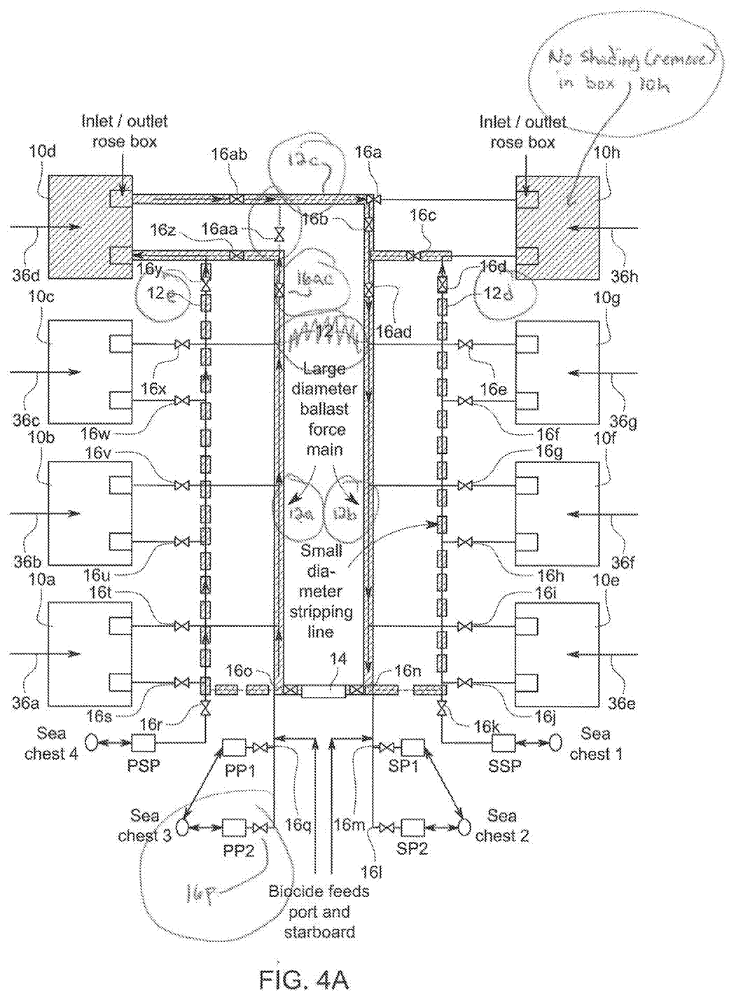

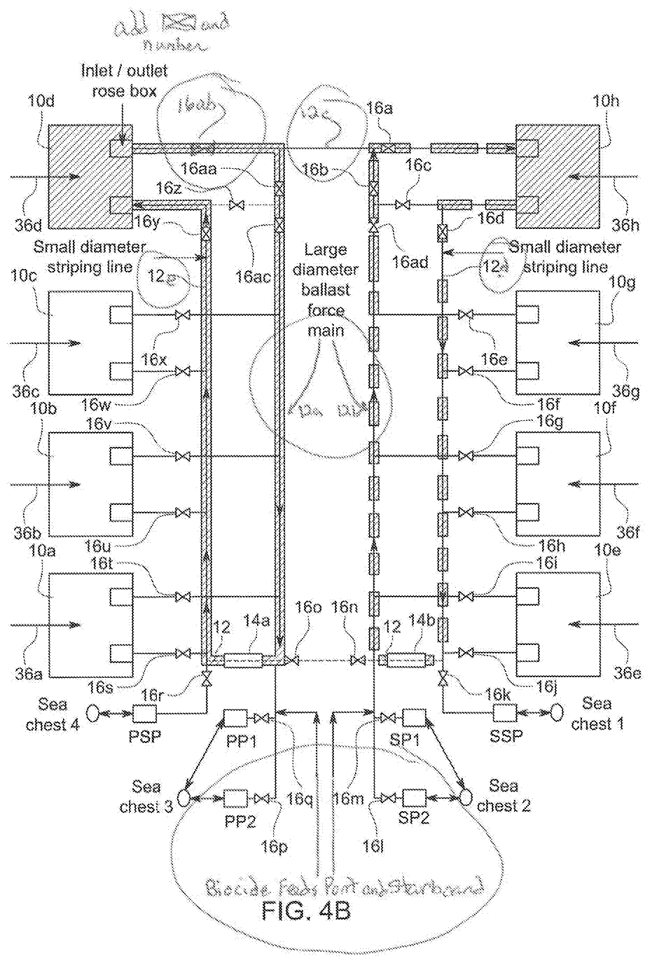

FIGS. 4A and 4B are ballast tank piping configuration used to interconnect tanks, 10a . . . d to increase water circulation between ballast tanks and to kill invasive species trapped in water force main line, 12.

FIG. 4A is a piping plan diagram for improved circulation of treated ballast water to kill invasive species, where piping configuration permits sharing of water trapped in port and starboard side main lines, 12a, b, using one circulation pump.

Visible in FIG. 4A are ballast tanks 10a through 10h, ballast tank pipes 12,13, water circulation pump 14, valves 16, gas supply pipes 36a through 36h.

In the exemplary embodiment shown, tanks, 10, on both the port and star port sides are filled by opening its valves, 16, allowing water captured through sea chest, 112a, 112b, that passes through force main, 12a, b arid pipes, 13a, b, to enter into tanks through a valve, illustrated as 16x and piping, 13a, for tank, 10c. Each tank, 10 may be stripped or topped off using a secondary Sea chest, 113a, b. Biocides for killing invasive species captured in tank known methods or may be fed through Biocide feed line, 116, to tank ,10, controlled by valves, 16. Additional biocides are fed into a specific tank, 10d, to over saturate or charge the tank, 10d. The over charged contents of port side tank, 10d, may be fed via valve, 16ab, to the seaport main force lines, 12b, where a water circulation pump 14 circulates water along the seaport side to the port side for two to twelve hours killing invasive species trapped in the force main lines, 12a, b. Each tank, 10, has a separate line, 12c, d, and valve, illustrated as 16w, for tank, 10c, to optionally allow any tank to be designated as the overcharging tank and fed through loop provided in the force main lines, 12a, b, by valves exemplified as 16ab water circulation pump, 14.

In the exemplary embodiment shown, gas supply pipes 36a through 36h supply air to diffusion grids, 40, for treating and mixing ballast water in tanks 10a through 10h. The embodiment allows for movement of ballast from the starboard side to the port side in a closed loop that can include one or both stripping lines and the force mains. The controlled circulation can continue in the loop until the pH in both the force main line 12, ballast tank 10 have equilibrated due to mixing resulting in mortality if invasive species throughout.

Similarly, during the pH lowering or depression step of the Standard Treatment Process (STP), the circulating pump can be used to reestablish the same closed loop used during dosing, allowing the CO₂ enriched gas or engine exhaust gas sparger system in tank 10d to cause the conversion of base contents, allowing both tank 10d and affected pipes including main force lines, 12 to achieve targeted pH values that meet ballast water discharge standards. Based on the amount of base or CO₂, and time of exposure or mixing, pH within the tank and affected piping, 12, may be controlled. The operating period required to achieve blending in both system components will be related to tank geometry and will decrease with increasing exchange rates.

Various embodiments also include force main lines, a port pump, and a starboard pump for filling ballast tanks 10a through 10k a biocide inlet for injecting a biocide ballast tank treatment into force main lines connected to ballast tanks 10a through 10k stripping lines, a port stripping pump, and a starboard stripping pump for emptying ballast tanks 10a through 10h; valves for controlling water circulation between ballast tanks 10a through 10h; and sea chests that supply water to fill ballast tanks or accept discharged water to empty ballast tanks. In the exemplary embodiment shown, force main lines and stripping lines are operatively coupled with inlet/outlet rose boxes in each ballast tank 10a through 10h.

In the exemplary embodiment shown, arrows show the direction of the flow of gas from gas supply pipes 36a through 36h, the direction of the flow of water, or the direction of the flow of biocide.

FIG. 4A show an example of the modified plumbing that allows for treatment (dosing or carbonation) of plumbing related ballast in selected tank 10d. The closed recirculating loop shown (solid highlight) is established by opening valves 16b, 16n, 16o, 16z, 16ab, 16ac and 16ad with all other valves closed, then starting circulating pump (CP) 14 to move water in the clockwise direction. Again, mixing in the loop, particularly in tank 10d, allows for equilibrium in water chemistry to be established throughout the loop. Equilibrium can also be established in the stripping line either concurrently with the force main or individually. In the latter case, valves 16b, 16b, 16d, 16n, 16o and 16y are open with all other valves closed, again allowing water to flow in the clockwise direction with activation of circulating pump 14 (FIG. 4A, dashed line highlight).

If concurrent treatment of the force main and stripping line ballast is required, valves 16b, 16b), 16d, 16n, 16o, 16y, 16z, 16ab, and 16ac are open with all others closed (FIG. 4A). The circulating pump is activated and valves 16b, 16ad, 16y and 16ac are used to throttle or balance flows to achieve equal or near equal flow velocities in each of the two pipeline components of the closed loop. FIG. 4B, solid highlight, shows the closed loop that can be established in a port side specific treatment effort (dosing or carbonation) made possible using two circulating pumps 14a and 14b. In this case, when circulating pump 14a is used, valves 16y, 16aa, 16ab and 16ac are open, with all other valves closed. A similar loop (dashed highlight) could be established concurrently, or sequentially, on the starboard side using circulating pump 14b with valves 16a, 16b, 16d, and 16ad open and all other valves on the starboard side closed.

Short pipe sections (not shown) couple the force main and stripping lines to inlet/outlet rose boxes located in tanks 10a through 10h. These short pipe sections include control valves 16o and 16n that in the closed position prevent mixing in the limited volume pipe runs required. This is easily corrected by installation of small pumps and isolation valves (not shown) that allow for short term movement of treated water from the ballast tank into the force main. The pumps would be operated, after the force main and stripping lines have been treated as described earlier, to provide a minimum of 8 pipe section volume exchanges. During this operation appropriate valves must be positioned to allow the ballast added to the force main, or stripping lines, to flow into one or more of the treated ballast tanks so as not to overpressure the piping. Short term activation of the closed loops described earlier based on use of the circulating pump(s) may also be used to reestablish uniform water chemistry throughout the system.

In addition to the STP, an algaecide treatment may be needed to meet regulatory targets for phytoplankton. Hence, the STP would be modified to allow the dosing of the ballast water either before, during or after treatment with NaOH, KOH or Ca(OH)2 or after the pH depression step with CO₂. The algaecide could be applied as a solid, liquid or wet slurry directly in the ballast plumbing lines, 11a, b, feeding the ballast tank or in the tank directly through a delivery port with mixing, or within the air bubble plume of the airlift diffuser grid with the airlift in operation. Dosing would be based on both Federal and state receiving water quality standards (biotic ligand models) as well as data establishing dose effect relationships under the conditions expected (temperature, alkalinity, hardness etc.). An attempt would be made to extend the duration of the holding time, after dosing, in the ballast tank (transit time) to maximize treatment effects on target algae species.

Sodium percarbonate or sodium carbonate peroxyhydrate (SCP) is the preferred algaecide, SCP is an adduct of sodium carbonate and hydrogen peroxide. It is a colorless, crystalline, hygroscopic and water-soluble solid. When added to water it breaks down to sodium carbonate and hydrogen peroxide. Hydrogen peroxide, in turn, breaks down to water and oxygen. SCP is not persistent in sediments or water. During use, OH radicals penetrate algal cell walls leading to the bleaching of chlorophyll a and destruction of the cell. Dosing requirements are related to algal concentrations with application rates of 5-25 pounds required per million gallons of water with low algal growth conditions and 50-250 pounds required with heavy algal growth conditions is available in both liquid and solid forms. Its use is preferred over copper sulfate as it avoids the potential pH effects on dosing requirements (elevated pH increases required copper sulfated dose) as well as the introduction of copper into receiving waters that may already, due to local geochemistry, be close to or exceed allowable copper concentrations.

FIG. 4B is an alternative piping plan diagram that achieves reduce time of killing invasive species trapped within minimum force lines, 12a, b, using the same design and components in FIG. 4 except, that a port side closed treatment loop and seaport side closed treatment loop with the aid of two circulation pumps, 14a, b.

In the exemplary embodiment shown, port ballast tanks 10a through 10d are not connected to starboard ballast tanks 10e through 10h. Water circulation pump 14a circulates water through ballast tank pipes 12a and port ballast tanks 10a through 10d and water circulation pump 14b circulates water through ballast tank pipes 12b and starboard ballast tanks 10e through 10h.

FIG. 48 shows the addition of two circulating pumps that allows the piping modifications disclosed in FIG. 4A to establish, if necessary, two independent closed loops (starboard and port) that couple the ballast tanks with the plumbing system for either selective dosing of specific tanks 10a through 10h or selective carbonation of specific tanks along with the respective plumbing ballast.

For example, in the standard ballast piping configuration, tank 10d could be filled during the SIP by allowing the port pump operatively coupled with valve 16q to force ballast through the force main plumbing system with valve 16q and 16ab in the open position and valves 6p, 16r, 16s, 16t, 16u, 16v, 16w, 16x, 16y, closed. During the fill operation the biocide is dosed as per STP, followed by a rinse flow that is used to bring the ballast tank led to the target fill elevation at which point valves 16q and 16r are closed. The biocide is then blended within the tank by application of compressed air, for example, applied to the tanks submerged gas diffusers thus establishing airlift like pumping behavior.

Air flow introduced in the tank is vented to the atmosphere via standard ballast tank vents positioned at or near the highpoint of tanks 10a through 10h (not, shown). Diffuser grids (not shown) through,gas supply pipes 36a through 36h is stopped soon after blending has been established to minimize the reaction of NaOH in the biocide with the CO₂ present in the atmosphere (about 400 ppm). After holding the water in the elevated pH condition for the required contact time, commercial CO₂ or engine exhaust would be applied to the tank/gas diffusers 40 (not shown) to initiate and carryout the pH lowering or depression step with induced mixing.

The operation of the system also results in the stripping of dissolved oxygen. Once this step is complete, engine exhaust flow through diffuser grids, 40 is interrupted and replaced by air to strip unnecessary free CO₂ from the water while concurrently bringing dissolved oxygen levels back up to near saturation concentrations to meet water quality standards. Without the use of a replenishment of oxygen by providing a post CO₂, air mixing step, the pH may drop too low beyond water quality standard resulting in known ecological effects.

Ballast water is then discharged from the tank during cargo loading operations by opening valve 16ab or 16aa and valve 16q and running the pump operatively coupled with valve 16q to release discharge ballast water out through a sea chest operatively coupled with the pump.

The force main system is unable to completely drain the ballast tank and so further removal of ballast requires that valves 16ab or 16aa and 16q are closed, the pump operatively coupled with valve 16q is shut clown and valves 16r and 16y are opened as the port side stripping pump is activated. Here, the ballast is discharged through a sea chest operatively coupled with valve 16r. With all water removed from, the tank, valves 16r and 16y are closed and the stripping pump is shut off.

The embodiments of the inventions described here are intended to (1), ensure all waters on board as ballast, including plumbing, or wetted surfaces, are exposed to the selected treatment (2), appropriate CO₂ sources are available when needed during treatment and that the gas mixtures applied do not result in residual toxicity (3), base reagents, are introduced at appropriate rates, at appropriate locations and at the appropriate time so as to maximize treatment effect and minimize reagent costs (4), allow for the addition and release of ballast while underway in those cases where additional ballast is required to stabilize the ship, or alter its draft and (6), to ensure complete and rapid mixing of the bulk solution with base reagents,. neutralizing gases and air despite varying ballast loads or ballast tank geometries.

It should be understood that the drawings are not necessarily to scale; instead, emphasis has been placed upon illustrating the principles of the invention. Moreover, it will be appreciated by those skilled in the art that the invention contemplates modifications and variations not departing from the principles and spirit of the invention, which includes treating ballast water and uniformly mixing its contents such that its pH may be lowered or elevated based on desired results.

1. A ballast water treatment system for eradicating invasive species in ballast tanks of a ship comprising:
a two source gas supply line comprising an engine connected to a fan with a valve intervening between said fan and said engine, the fan permits gas to flow to a burner that reheats the gas that enters into a catalytic converter, the gas passing through the catalytic converter flows into an exhaust purification component including a first and second gas chamber containing a water sprayer and demister with a centrifugal separator connected to each said chamber to remove solid contaminants from each said chamber, a valve capable of stopping CO₂ from flowing downstream to a compressor that blows air through a gas inlet into and through a diffuser grid placed in each ship ballast water tanks;
the grid comprising at least four adjacent hollow sidewalls with at least one rib connecting two of said sidewalls, each said rib has at least one aperture capable of releasing said gas into a liquid placed in said tank, and a guide rail passing through the grid to allow movement of the grid;
a water treatment piping system that interconnects said ballast tanks comprising
each said ballast tank connected by valve to a main pipe line that loads water external o said ship to said tank, and to secondary pipe for stripping or top from a said tank, wherein said secondary pipe line connected to at least a plurality of said tanks on a port side of said ship is the same;
and a pump connected to said main pipe causing water to flow within a closed loop from at least one said tank through said main pipe line.

2. A diffusion grid system for eradicating invasive species in ballast water contained within a ship ballast tank, comprised of:
at least four adjacent hollow sidewalls with at least one rib connecting two of said sidewalls, each said rib has at least one aperture capable of releasing said gas into a liquid placed in said tank, and a guide rail passing through the grid to allow movement of the grid.

3. A water treatment piping system that interconnects said ballast tanks comprising:
A plurality of ballast water tanks in a ship connected by valve to a main pipe line that loads water external to said ship to each said tank, and to secondary pipe line for stripping or top off of each said ballast tank, wherein said secondary pipe line connected to at least a plurality of said tanks on a port side of said ship is the same;
and a pump connected to said main pipe causing water to flow within a closed loop from at least one said tank through said main pipe line.
